(19) United States
(12) Patent Application Publication
(10) Pub. No.: US 2010/0272046 A1
(43) Pub. Date: Oct. 28, 2010

(54) Apparatus and Method for Handling Priority of MAC Control Element

(76) Inventor: Yu-Hsuan Guo, Taipei City (TW)

Correspondence Address: NORTH AMERICA INTELLECTUAL PROPERTY CORPORATION, P.O. BOX 506, MERRIFIELD, VA, 22116, US

(21) Appl. No.: 12/765,892

(22) Filed: Apr. 23, 2010

Related U.S. Application Data
(60) Provisional application No. 61/172,229, filed on Apr. 24, 2009.

(51) Int. Cl. H04W 76/04

(52) U.S. Cl. 370/329

(57) ABSTRACT

The present invention provides a method for handling priority of MAC control elements in a user equipment (UE) of a wireless communication system. The method includes steps of forming a plurality of transport blocks for uplink transmission in a same sub-frame, including a BSR MAC control element in a first transport block of the plurality of transport blocks, and setting a MAC control element for Padding PHR to have higher priority than a MAC control element for Padding BSR when forming a second transport block of the plurality of transport blocks.

### CROSS REFERENCE TO RELATED APPLICATIONS

This application claims the benefit of U.S. Provisional Application No. 61/172,229, filed on Apr. 24, 2009 and entitled “Method and apparatus for improving resource utilization and relaying in a wireless communication system”, the contents of which are incorporated herein by reference.

### BACKGROUND OF THE INVENTION

1. Field of the Invention

The present invention relates to a method and apparatus for handling priority of MAC Control Elements, and more particularly, to a method and apparatus for handling a BSR MAC control element in a user equipment of a wireless communication system, so as to avoid redundant BSR transmission in a same sub-frame.

2. Description of the Prior Art

Long Term Evolution wireless communication system (LTE system), an advanced high-speed wireless communication system established upon the 3G mobile telecommunication system, supports only packet-switched transmission, and tends to implement both Medium Access Control (MAC) layer and Radio Link Control (RLC) layer in one single communication site, such as in base stations (Node Bs) alone rather than in Node Bs and RNC (Radio Network Controller) respectively, so that the system structure becomes simple.

According to the current specification (3GPP TS 36.321 V8.5.0), a buffer status reporting procedure is used to provide a serving eNB with information about the amount of data available for transmission in an uplink (UL) transmission buffer of the UE. A buffer status report (BSR) is triggered when a triggering event occurs, and is categorized by regular BSR, periodic BSR, and padding BSR accordingly. A regular BSR is triggered when UL data, for a logical channel which belongs to a logic channel group (LCG), becomes available for transmission and either the data belongs to a logical channel with higher priority than the priorities of the logical channels which belong to any LCG and for which data is already available for transmission, or there is no data available for transmission for any of the logical channels which belong to a LCG; or when a retransmission timer “retxBSR-Timer” expires and the UE has data available for transmission for any of the logical channels which belong to a LCG. A periodic BSR is triggered when a periodic BSR timer “Periodic_BSR_timer” expires. A padding BSR is triggered when UL resources are allocated and an amount of padding bits is equal to or greater than the size of a BSR MAC control element plus its sub-header.

After the BSR is triggered, if the UE has UL resources allocated to a new transmission for a current Transmission Time Interval (TTI), the UE MAC layer instructs a multiplexing and assembly procedure to generate a BSR MAC control element that is included in a MAC protocol data unit (PDU), such that information about the amount of data available for transmission in the UL buffers can be reported. Accordingly, the network can determine the total amount of data available across one or all logical channel groups.

The BSR MAC control elements can be categorized into the following three formats: long BSR, short BSR and truncated BSR. A short or truncated BSR MAC control element is 1-byte long, and has 8 bits, where the former 2 bits indicate one LCG which buffer status is being reported, and the remaining six bits indicate the amount of buffered data available across the LCG. A long BSR MAC control element is 3-byte long, and utilized for reporting buffered data amount of all LCGs.

For the regular and periodic BSR, the format of BSR MAC control element is determined according to the number of LCGs having uplink buffered data. If there is only one LCG or no LCG having uplink buffered data available for transmission, the short BSR MAC control element is reported. Conversely, if there are more than one LCG having uplink buffered data available for transmission, the long BSR MAC control element is reported.

For the padding BSR, the BSR MAC control element format is determined according to the number of padding bits remaining in the MAC PDU. If the number of padding bits is sufficient enough, the long BSR MAC control element is used, for reporting buffered data amount of all LCGs. If the number of padding bits is not enough to accommodate the long BSR MAC control element and there is only one LCG or no LCG having uplink buffered data available for transmission, the short BSR MAC control element is used, for reporting buffered data amount of the LCG. However, if the number of padding bits is not enough to accommodate the long BSR MAC control element but there are more than one LCG having uplink buffered data available for transmission, the truncated BSR MAC control element is used, for reporting buffered data amount of a LCG with the highest priority logical channel having buffered data available for transmission.

On the other hand, a power headroom reporting procedure is used to provide the serving eNB with information about the difference between the UE maximum transmit power and the estimated power for UL-SCH transmission. A power headroom report (PHR) is triggered when one of the following triggering events occurs: (1) when a prohibit PHR timer “PROHIBIT_PHR_TIMER” expires and a path loss of the UE has changed more than a specific value “DL_PathlossChange” since the last PHR when the UE has UL resources for new transmission; (2) a periodic PHR timer “PERIODIC_PHR_TIMER” expires; and (3) upon configuration or reconfiguration of the power headroom reporting functionality by upper layers. After the PHR is triggered, if the UE has UL resources allocated for a new transmission for this TTI, and the UL resources are able to accommodate a PHR MAC control element, the UE MAC layer obtains the value of the power headroom from the physical layer, and instructs the multiplexing and assembly procedure to generate a PHR MAC control element, so that the PHR is reported to the network on the UL-SCH resource. The PHR MAC control element is included in a MAC PDU, and has 8 bits: 2 bits in the beginning of the PHR MAC control element are reserved bits, and the remaining 6 bits are used for indicating the power headroom level.

Besides, it has been proposed in the prior art that Padding BSR is not triggered when no LCG has buffered data available for transmission, and that Padding PHR is triggered and included in a transport block only when Padding BSR is not triggered, in order to have padding bits of MAC PDUs used more efficiently. For example, if an amount of padding bits is equal to or greater than the size of a PHR MAC control element plus its sub-header in this case, Padding PHR can be triggered by the UE, to inform the network power information of the UE more frequently.

Recently, the 3GPP is involved in the further advancements for E-UTRA and proposes an LTE-Advanced (LTE-A) system as an enhancement of the LTE system. Carrier aggregation, where two or more component carriers are aggregated, is introduced into the LTE-A system in order to support wider transmission bandwidths, e.g. up to 100 MHz and for spectrum aggregation. A UE of the LTE-A system utilizes multiple component carriers instead of a single carrier used in the former LTE system, to establish multiple links for simultaneously receiving and transmitting on each component carrier.

In addition, the LTE-A system also supports Multi-input and multi-output, or MIMO, technology, which refers to the use of multiple antennas both at the transmitter and receiver, so as to multiply channel capacity without additional bandwidth or transmit power. Generally, MIMO technology can be classified into the following operating modes, including: Spatial Multiplexing, Transmit Diversity and Beam Forming. When the Spatial Multiplexing is activated, in the transmitter, a high rate signal is split into multiple lower rate streams and each stream is transmitted from a different antenna in the same frequency channel. Spatial Multiplexing is very powerful technique for increasing channel capacity at higher Signal to Noise Ratio (SNR).

Therefore, through carrier aggregation and/or MIMO technology, more than one transport block may be transmitted in the same sub-frame, or called transmission time interval (TTI), by the UE of LTE-A system. Please note that, the abovementioned BSR, PHR, and associated procedures are defined in the MAC specification of LTE system, and are not clearly specified in the LTE-A system.

From the above, when multiple transport blocks are formed by the UE for transmitting in the same sub-frame, the BSR MAC control element may be included in one of the transport blocks. However, Padding BSR may possibly be triggered if there is some remaining resource when constructing the other transport blocks for the same sub-frame. Under this condition, more than one BSR may be transmitted at the same time, causing waste of radio resources.

### SUMMARY OF THE INVENTION

It is therefore an objective of the present invention to provide a method and apparatus for handling priority between MAC control elements in a UE of a wireless communications system.

According to the present invention, a method for handling priority of MAC control elements in a UE of a wireless communication system is disclosed. The method includes steps of forming a plurality of transport blocks for transmitting in a same sub-frame; including a first BSR MAC control element in a first transport block of the plurality of transport blocks; and setting a MAC control element for Padding PHR to have higher priority than a MAC control element for Padding BSR when forming a second transport block of the plurality of transport blocks.

According to the present invention, a communications device for handling priority of MAC control elements in a UE of a wireless communication system is disclosed. The communications device includes a processor for executing a program, and a memory, coupled to the processor, for storing the program. The program includes steps of forming a plurality of transport blocks for transmitting in a same sub-frame; including a first BSR MAC control element in a first transport block of the plurality of transport blocks; and setting a MAC control element for Padding PHR to have higher priority than a MAC control element for Padding BSR when forming a second transport block of the plurality of transport blocks.

According to the present invention, a method for handling a BSR MAC control element in a UE of a wireless communication system is disclosed. The method includes steps of forming a plurality of transport blocks for transmitting in a same sub-frame; including a first BSR MAC control element in a first transport block of the plurality of transport blocks; and prohibiting a MAC control element for Padding BSR from being included in a second transport block of the plurality of transport blocks when the second transport block is formed.

According to the present invention, a communications device for handling a BSR MAC control element in a UE of a wireless communication system is disclosed. The communications device includes a processor for executing a program, and a memory, coupled to the processor, for storing the program. The program includes steps of forming a plurality of transport blocks for transmitting in a same sub-frame; including a first BSR MAC control element in a first transport block of the plurality of transport blocks; and prohibiting a MAC control element for Padding BSR from being included in a second transport block of the plurality of transport blocks when the second transport block is formed.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of a wireless communications system.

FIG. 2 is a function block diagram of a wireless communications device.

FIG. 3 is a diagram of program code of FIG. 2.

FIG. 4 is a flowchart of a process according to an embodiment of the present invention.

FIG. 5 is a flowchart of a process according to another embodiment of the present invention.

### DETAILED DESCRIPTION

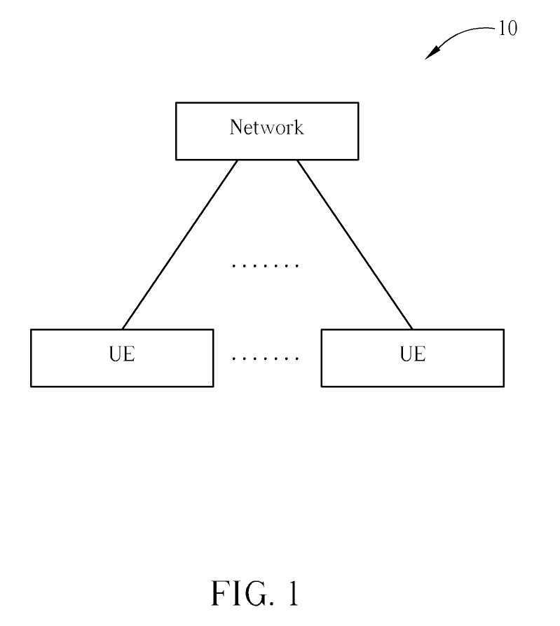

Please refer to FIG. 1, which illustrates a schematic diagram of a wireless communications system 10. The wireless communications system 10 is preferred to be an LTE-advanced system, and is briefly composed of a network and a plurality of user equipments (UEs). In FIG. 1, the network and the UEs are simply utilized for illustrating the structure of the wireless communications system 10. Practically, the network may comprise a plurality of base stations (Node Bs), radio network controllers and so on according to actual demands, and the UEs can be devices such as mobile phones, computer systems, etc.

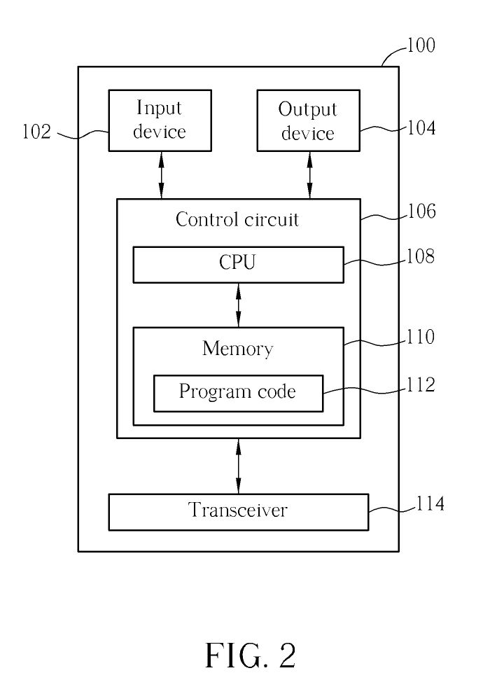

Please refer to FIG. 2, which is a functional block diagram of a communications device 100 in a wireless communications system. The communications device 100 can be utilized for realizing the UEs in FIG. 1, and the wireless communications system is preferably the LTE system. For the sake of brevity, FIG. 2 only shows an input device 102, an output device 104, a control circuit 106, a central processing unit (CPU) 108, a memory 110, a program 112, and a transceiver 114 of the communications device 100. In the communications device 100, the control circuit 106 executes the program code 112 in the memory 110 through the CPU 108, thereby controlling an operation of the communications device 100. The communications device 100 can receive signals input by a user through the input device 102, such as a keyboard, and can output images and sounds through the output device 104, such as a monitor or speakers. The transceiver 114 is used to receive and transmit wireless signals, delivering received signals to the control circuit 106, and outputting signals generated by the control circuit 106 wirelessly. From a perspective of a communications protocol framework, the transceiver 114 can be seen as a portion of Layer 1, and the control circuit 106 can be utilized to realize functions of Layer 2 and Layer 3.

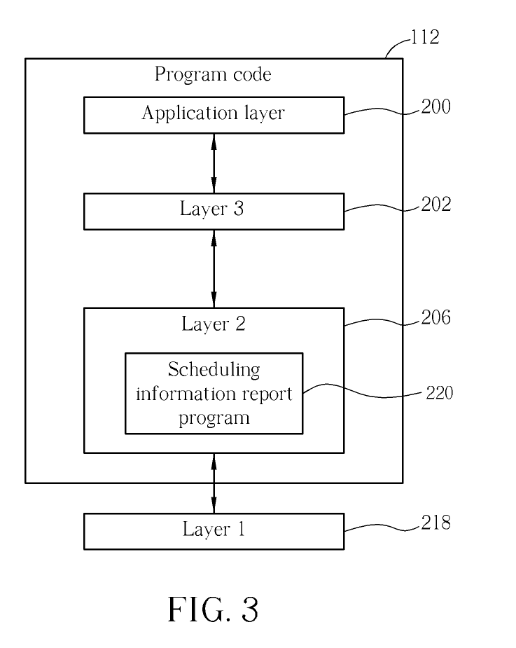

Please continue to refer to FIG. 3. FIG. 3 is a diagram of the program 112 shown in FIG. 2. The program 112 includes an application layer 200, a Layer 3 202, and a Layer 2 206, and is coupled to a Layer 1 218. The Layer 3 202 performs radio resource control. The Layer 2 206 comprises a Radio Link Control (RLC) layer and a Medium Access Control (MAC) layer, and performs link control. The Layer 1 218 performs physical connections.

The MAC layer of the Layer 2 206 performs a Buffer Status reporting procedure and a Power Headroom reporting procedure, to report scheduling information such as uplink buffer status or power usage status to the serving base station, such that the network can allocate transmission resource and make scheduling decision efficiently. Besides, as mentioned above, MIMO and carrier aggregation are introduced in the LTE advanced system, and thus more than one transport block may be transmitted by the UE in a same sub-frame, or called transmission time interval (TTI). In such a situation, the embodiment of the present invention provides a scheduling information report program 220, for appropriately transmitting scheduling information such as power headroom report (PHR) and buffer status report (BSR) when MIMO and/or carrier aggregation is activated, so as to avoid waste of radio resources.

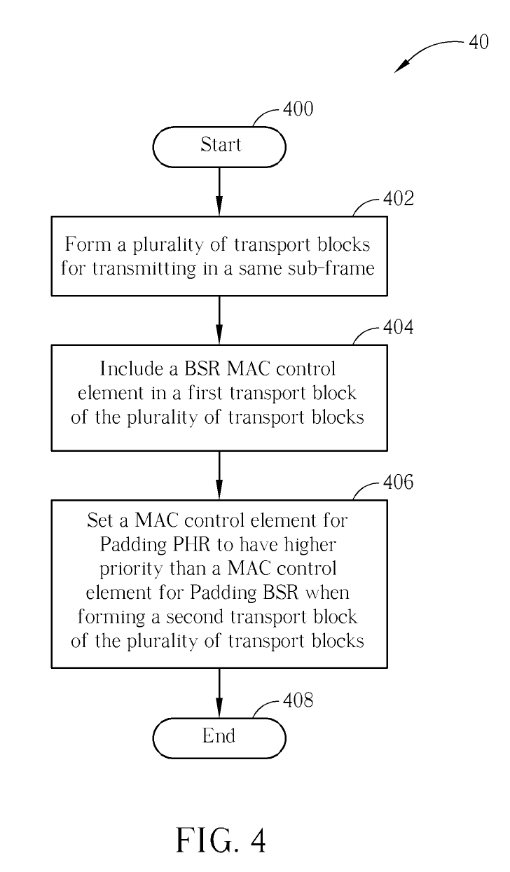

Please refer to FIG. 4, which illustrates a schematic diagram of a process 40. The process 40 is utilized for handling priority of MAC control elements in a UE of the wireless communications system 10, and can be compiled into the scheduling information report program 220. The process 40 includes the following steps:

Step 400: Start.

Step 402: Form a plurality of transport blocks for transmitting in a same sub-frame.

Step 404: Include a BSR MAC control element in a first transport block of the plurality of transport blocks.

Step 406: Set a MAC control element for Padding PHR to have higher priority than a MAC control element for Padding BSR when forming a second transport block of the plurality of transport blocks.

Step 408: End.

According to the process 40, when the plurality of transport blocks are formed by the UE for transmitting in the same sub-frame, if the first transport block includes a BSR MAC control element, the MAC control element for Padding PHR has higher priority than a MAC control element for Padding BSR when the second transport block of the plurality of transport blocks is formed.

That is to say, compared with the prior art in which Padding BSR would be triggered when the second transport block has remaining resources, the embodiment of the present invention gives Padding PHR a higher priority, to avoid BSRs that include same buffer information being redundantly transmitted in the same sub-frame and causing waste of radio resources.

Please note that, the BSR MAC control element being included in the first transport block can be generated by any type of BSR, such as Regular BSR, Periodic BSR and Padding BSR. However, since the Padding BSR may report by a long, short or truncated BSR MAC control element, buffered data amount of all LCGs are not entirely reported to the network if the truncated BSR MAC control element is used. Thus, in the embodiment of the present invention, the BSR MAC control element included in the first transport block is preferably limited to a long or short BSR MAC control element.

When the BSR MAC control element included in the first transport block is a truncated BSR MAC control element, buffered data amount of all LCGs are not yet reported to the network entirely. Thus, Padding BSR still has higher priority to be triggered when forming the rest transport blocks of the same sub-frame, such that the buffered data amount of all LCGs can be reported.

Conversely, when the BSR MAC control element included in the first transport block is a long or short BSR MAC control element, buffered data amount of all LCGs are already entirely reported. Thus, if there is some remaining source when forming the rest transport blocks, Padding PHR shall have higher priority to be triggered than Padding BSR.

As a result, the embodiment of the present invention can avoid more than one BSR that include same buffer information being redundantly transmitted in the same sub-frame, which may cause waste of radio resources.

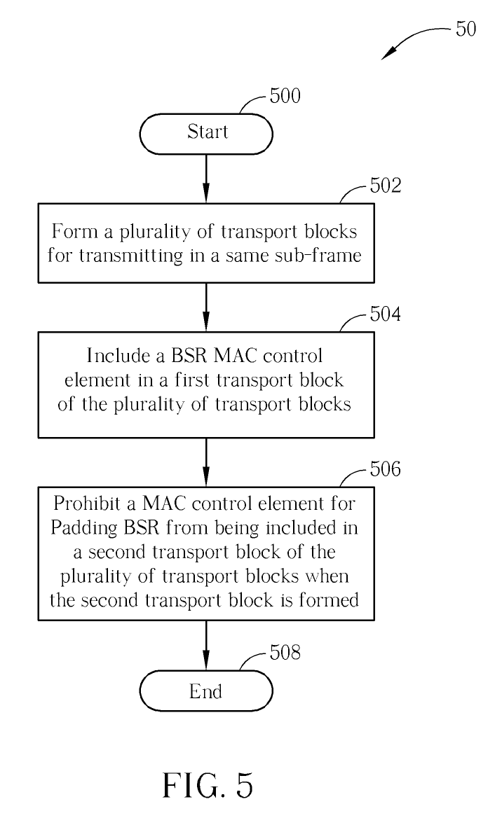

Besides, please refer to FIG. 5, which illustrates a schematic diagram of a process 50. The process 50 is utilized for handling a BSR MAC control element in a UE of the wireless communications system 10, and can be compiled into the scheduling information report program 220 as well. The process 50 includes the following steps:

Step 500: Start.

Step 502: Form a plurality of transport blocks for transmitting in a same sub-frame.

Step 504: Include a BSR MAC control element in a first transport block of the plurality of transport blocks.

Step 506: Prohibit a MAC control element for Padding BSR from being included in a second transport block of the plurality of transport blocks when the second transport block is formed.

Step 508: End.

According to the process 50, when the plurality of transport blocks are formed by the UE for transmitting in the same sub-frame, if the first transport block includes a BSR MAC control element, the MAC control element for Padding BSR is prohibited from being included in a second transport block of the plurality of transport blocks when the second transport block is formed.

As a result, the embodiment of the present invention can also avoid more than two BSRs that include same buffer information being redundantly transmitted in the same sub-frame and waste of radio resources.

Similarly, the BSR MAC control element being included in the first transport block can be generated by any type of BSR, and is only limited to a long or short BSR MAC control element. Thus, if the BSR MAC control element included in the first transport block is a truncated BSR MAC control element, since buffered data amount of all LCGs are not yet reported to the network entirely, Padding BSR can still be triggered when forming the rest transport blocks of the same sub-frame.

To sum up, by the above two methods, the embodiment of the present invention avoids more than two BSRs that include same buffer information being redundantly transmitted in the same sub-frame, and waste of radio resources.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method for handling priority of MAC control elements in a user equipment (UE) of a wireless communication system, the method comprising:
forming a plurality of transport blocks for transmitting in a same sub-frame;
including a first BSR MAC control element in a first transport block of the plurality of transport blocks; and
setting a MAC control element for Padding PHR to have higher priority than a MAC control element for Padding BSR when forming a second transport block of the plurality of transport blocks.

2. The method of claim 1, wherein the plurality of transport blocks is formed due to activation of uplink spatial multiplexing.

3. The method of claim 1, wherein the first BSR MAC control element is generated by a Regular BSR.

4. The method of claim 1, wherein the first BSR MAC control element is generated by a Periodic BSR.

5. The method of claim 1, wherein the first BSR MAC control element is generated by a Padding BSR.

6. The method of claim 1, wherein the first BSR MAC control element is either a long BSR MAC control element or a short BSR MAC control element.

7. The method of claim 1, wherein the first transport block is a new transmission.

8. A communication device for handling priority of MAC control elements in a user equipment (UE) of a wireless communication system, the communication device comprising:
a processor for executing a program; and
a memory coupled to the processor for storing the program; wherein the program comprises:
forming a plurality of transport blocks for transmitting in a same sub-frame;
including a first BSR MAC control element in a first transport block of the plurality of transport blocks; and
setting a MAC control element for Padding PHR to have higher priority than a MAC control element for Padding BSR when forming a second transport block of the plurality of transport blocks.

9. The communication device of claim 8, wherein the plurality of transport blocks is formed due to activation of uplink spatial multiplexing.

10. The communication device of claim 8, wherein the first BSR MAC control element is generated by a Regular BSR.

11. The communication device of claim 8, wherein the first BSR MAC control element is generated by a Periodic BSR.

12. The communication device of claim 8, wherein the first BSR MAC control element is generated by a Padding BSR.

13. The communication device of claim 8, wherein the first BSR MAC control element is either a long BSR MAC control element or a short BSR MAC control element.

14. The communication device of claim 8, wherein the first transport block is a new transmission.

15. A method for handling a Buffer Status Report (BSR) MAC control element in a user equipment (UE) of a wireless communication system, the method comprising:
forming a plurality of transport blocks for transmitting in a same sub-frame;
including a first BSR MAC control element in a first transport block of the plurality of transport blocks; and
prohibiting a MAC control element for Padding BSR from being included in a second transport block of the plurality of transport blocks when the second transport block is formed.

16. The method of claim 15, wherein the plurality of transport blocks is formed due to activation of uplink spatial multiplexing.

17. The method of claim 15, wherein the first BSR MAC control element is generated by a Regular BSR.

18. The method of claim 15, wherein the first BSR MAC control element is generated by a Periodic BSR.

19. The method of claim 15, wherein the first BSR MAC control element is generated by a Padding BSR.

20. The method of claim 15, wherein the first BSR MAC control element is either a long BSR MAC control element or a short BSR MAC control element.

21. The method of claim 15, wherein the first transport block is a new transmission.

22. A communication device for handling a Buffer Status Report (BSR) MAC control element in a user equipment (UE) of a wireless communication system, the communication device comprising:
a processor for executing a program; and
a memory coupled to the processor for storing the program; wherein the program comprises:
forming a plurality of transport blocks for transmitting in a same sub-frame;
including a first BSR MAC control element in a first transport block of the plurality of transport blocks; and
prohibiting a MAC control element for Padding BSR from being included in a second transport block of the plurality of transport blocks when the second transport block is formed.

23. The communication device of claim 22, wherein the plurality of transport blocks is formed due to activation of uplink spatial multiplexing.

24. The communication device of claim 22, wherein the first BSR MAC control element is generated by a Regular BSR.

25. The communication device of claim 22, wherein the first BSR MAC control element is generated by a Periodic BSR.

26. The communication device of claim 22, wherein the first BSR MAC control element is generated by a Padding BSR.

27. The communication device of claim 22, wherein the first BSR MAC control element is either a long BSR MAC control element or a short BSR MAC control element.

28. The communication device of claim 22, wherein the first transport block is a new transmission.
